(19) United States
(12) Patent Application Publication
(10) Pub. No.: US 2012/0309609 A1
(43) Pub. Date: Dec. 6, 2012

(54) COMPOSITE MATERIAL WITH CONTROLLED COEFFICIENT OF THERMAL EXPANSION WITH OXIDIC CERAMICS AND PROCESS FOR OBTAINING SAME

(76) Inventors: Ramon Torrecillas San Millan, Oviedo (Asturias) (ES); Olga Garcia Moreno, Oviedo (Asturias) (ES); Adolfo Fernandez Valdes, Llanera (Asturias) (ES)

(21) Appl. No.: 13/517,214

(22) PCT Filed: Dec. 20, 2010
(86) PCT No.: PCT/ES10/70850

§ 371 Date: Aug. 21, 2012

(30) Foreign Application Priority Data
Dec. 21, 2009 (ES) P200931218

(51) Int. Cl. C04B 35/00; C04B 35/195; C04B 35/64; C04B 35/19

(52) U.S. Cl. 501/134; 501/1; 501/153; 501/152; 501/154; 264/681; 264/667; 264/483

(57) ABSTRACT

The present disclosure relates to a composite material comprising a ceramic component having a negative coefficient of thermal expansion, and oxidic ceramic particles, to its obtainment process and to its uses in microelectronics, precision optics, aeronautics and aerospace.

The present invention relates to a composite material comprising a ceramic component, characterized in that it has a negative coefficient of thermal expansion, and oxidic ceramic particles, to its obtainment process and to its uses in microelectronics, precision optics, aeronautics and aerospace.

### PRIOR ART

Materials with low coefficient of thermal expansion (CTE) have a broad range of applications in very different fields. These types of materials are required in many types of precision apparatus and in instrumentation equipment in high-technology systems, in the microelectronics industry and precision optics. In short, in all those applications wherein dimensional stability has to be guaranteed of a precision element with changes in temperature, which makes it necessary to decrease the CTE of the materials that form these elements. The imbalance in the thermal expansion in elements manufactured with different materials may also be resolved using the design of composites with a required (and homogeneous) CTE. The design of these materials with tailored CTE can be tackled using the combination of components with positive and negative expansion. This tailored design of the composites' CTE can be carried out for different temperatures, so that the final field of application of the components with zero CTE will depend on whether the other characteristics that the specific functionality for that application requires are achieved. The family of ceramics and glass-ceramics of lithium aluminosilicate (LAS) is frequently used for this purpose in many fields of application; from glass-ceramics for kitchens to mirrors for satellites. Some mineral phases of this family have a negative CTE which allows their use in composites with controlled and tailored CTE. Frequently, materials with negative CTE have a low resistance to fracture, since their negativity is due to a strong anisotropy between the different crystallographic orientations, wherein negative expansion is usually found in one of them and positive expansion in the other two. Anisotropy usually causes microfissures which give the result of low values in the mechanical properties of these materials. However, the usefulness of these expansion properties for the manufacture of composites with zero CTE has a wide range of potential in engineering, photonics, electronics and/or specific structural applications (Roy, R. et al., Annual Review of Materials Science, 1989, 19, 59-81). The phase with negative expansion in the LAS system is β-eucryptite (LiAlSiO₄), due to the great negative expansion in the direction of one of its crystallographic axes. The spodumene (LiAlSi₂O₆) and petalite (LiAlSi₄O₁₀) phases have CTEs close to zero. The traditional method of manufacturing materials with LAS composition is the processing of glass to produce glass-ceramics. This method involves the forming of glass to later apply a heat treatment at lower temperatures for the subsequent precipitation of crystalline LAS phases and thus control its CTE. On occasions this process produces heterogeneous materials and, of course, as it is glass, its mechanical properties (rigidity and resistance) are not sufficiently high for many industrial applications compared to ceramics. This is the case of Zerodur® (marketed by Schott) widely used in a multitude of applications but with excessively low resistance to fracture and tensile modulus values. An alternative to glass-ceramics is, therefore, necessary if better mechanical properties are required. There are other ceramic materials with CTE close to zero such as cordierite as disclosed in U.S. Pat. No. 4,403,017, or Invar® likewise having insufficient mechanical properties. An alternative to the preparation of materials with low CTE consists of the addition of a second phase with positive coefficient of thermal expansion to a LAS ceramic matrix whose CTE is negative, as in the cases U.S. Pat. No. 6,953,538, JP2007076949 or JP2002220277, and patent application P200930633. This latter option is very interesting as both the CTE value and the other properties can be adjusted by the addition of the suitable proportions of second phases in the matrix. On the other hand, and bearing in mind that the end properties of the material are a consequence of the combination of two or more components, the main problem of these composites lies in managing to control the CTE value for a wide temperature range. Thus, in U.S. Pat. No. 6,953,538, JP2007076949 or JP2002220277, the temperature ranges wherein high dimensional stability is achieved are approximately 30-50° C. In patent application P200930633 the temperature range for a CTE value close to zero is expanded.

Patent (U.S. Pat. No. 6,566,290B2) discloses a composite material with LAS matrix for application in the automotive field, such as filters in diesel engines, in which a material is protected using low CTE but having high porosity (up to 35-65% by volume). These materials do not meet the requirements of improved mechanical properties.

### DESCRIPTION OF THE INVENTION

The present invention provides a composite material having a ceramic matrix and oxidic ceramic particles, which offers excellent mechanical and thermal properties and high resistance to oxidation; it also provides a process for obtaining same, and its uses in microelectronics, precision optics, aeronautics and aerospace.

A first aspect of the present invention relates to a material comprising:
a. A ceramic component, and
b. oxidic ceramic particles,
   where said material has a coefficient of thermal expansion between −6×10⁻⁶° C⁻¹ and 6.01×10⁻⁶ ° C⁻¹.

In the present invention, “composite material” is understood as materials formed by two or more components that can be distinguished from one another; they have properties obtained from the combinations of their components, being superior to the materials forming them separately.

In the present invention “coefficient of thermal expansion” (CTE) is understood as the parameter reflecting the variation in the volume undergone by a material when it is heated.

The ceramic component is preferably selected from between Li₂O:Al₂O₃:SiO₂ or MgO:Al₂O₃:SiO₂, this component being more preferably β-eucryptite or cordierite.

The said ceramic component has a proportion with respect to the end material greater than 0.1% by volume.

Oxidic ceramic particles are preferably an oxide of at least one element, wherein said element is selected from: Li, Mg, Ca, Y, Ti, Zr, Al, Si, Ge, In, Sn, Zn, Mo, W, Fe or any combination thereof.

Oxidic ceramic particles are more preferably selected from alumina or mullite.

In the case of the oxidic ceramic particles being more preferably of a spinel type structure, they are selected even more preferably from among MgAl₂O₄, FeAl₂O₄ or any of the solid solutions resulting from combinations of both.

In a preferred embodiment oxidic ceramic particles have a size of between 20 and 1000 nm.

The advantages of the material of the present invention by using alumina (or another oxidic component) as a second phase in these composites lie in: the possibility of obtaining and using these materials in high temperature oxidizing atmospheres, while maintaining the CTE at values close to zero or controlled, low density composite with improved mechanical properties compared to pure LAS ceramics.

The present invention is based on new composite ceramic materials based on aluminosilicates with negative CTE and second phases of oxidic ceramic particles. The end composition of the material can be adjusted depending on the content of aluminosilicate with negative CTE used, which determines the required amount of the second oxidic phase to obtain an end material with CTE according to the desired needs.

A second aspect of the present invention relates to an obtainment process of the material as previously described, comprising the stages:
a. Mixing of the ceramic component with the oxidic ceramic particles in a solvent,
b. drying of the mixture obtained in (a),
c. forming of the material obtained in (b),
d. sintering of the material obtained in (c).
The solvent used in stage (a) is selected from water, anhydrous alcohol or any of their combinations, more preferably the anhydrous alcohol is anhydrous ethanol.

The mixing of stage (a) is performed preferably between 100 and 500 r.p.m. This mixing can be performed in an attrition mill. The processing conditions of the composite material have a decisive influence on critical features of the material formed, such as its density or porosity distribution, and which largely determine the possibility of obtaining a dense material by means of solid state sintering. During the powder mixture processing it is necessary to obtain a homogeneous distribution of the various components avoiding the formation of agglomerates, which is especially important in the case of nanometric powders.

The drying of stage (b) in a preferred embodiment is performed by atomization.

In the present invention “atomization” is understood as a method of drying by the pulverization of solutions and suspensions with an airstream.

The forming of stage (c) is performed preferably by cold or hot isostatic pressing.

In the present invention “isostatic pressing” is understood as a compacting method which is performed by hermetically enclosing the material, generally in the form of powder, in moulds, applying a hydrostatic pressure via a fluid; the parts thus obtained have uniform and isotropic properties.

When the cold isostatic pressing is performed, it is more preferably performed at pressures between 100 and 400 MPa.

Control over the reactivity of the phases at the sintering process allows adjustment of the CTE of the composite while maintaining a low density and improved mechanical properties and flexural rigidity as compared to the LAS monolithic ceramics.

The sintering temperature of stage (d) is preferably between 700 and 1600 ° C. Stage (d) of sintering can be performed without the application of pressure or applying uniaxial pressure.

When it is performed without applying pressure, the sintering can be performed in a conventional oven, whilst when a uniaxial pressure is applied during the sintering it can be performed by Spark Plasma Sintering (SPS) or Hot-Press sintering. In the latter two cases, stages (c) and (d) are performed in a single stage.

When the sintering is performed without applying pressure it is performed at a temperature between 1100 and 1600° C., with a heating ramp between 0.5 and 50° C./min, remaining at this temperature for 0.5 and 10 hours.

In a more preferred embodiment the forming and sintering stages (c) and (d) are carried out by Spark Plasma Sintering (SPS) applying a uniaxial pressure of between 2 and 100 MPa at a temperature of between 700 and 1600° C. with a heating ramp of between 2 and 300° C./min, remaining at this temperature for a period of between 1 and 120 min. This sintering method enables obtaining materials with controlled grain size using short periods of time.

In a more preferred embodiment the forming and sintering stages (c) and (d) are carried out through hot press sintered applying a uniaxial pressure of between 5 and 150 MPa at a temperature of between 900 and 1600° C. with a heating ramp of between 0.5 to 100° C./min, remaining at this temperature for 0.5 to 10 hours. This procedure can be performed using the Hot Press method.

The alternative presented in the present invention is the obtainment of ceramic materials with a low coefficient of thermal expansion and controlled in a wide temperature range, which makes them adaptable to a multitude of applications, due to their mechanical properties, their low density and stability at high temperatures in an oxidizing atmosphere.

The preparation is carried out by a simple manufacturing process of nanocomposite powder, which is formed and sintered in solid state by different techniques, avoiding the formation of glass and, in consequence, achieving improved mechanical properties. A β-eucryptite matrix has been selected and a second stage of α-alumina or mullite in nanoparticulate form, with the aim of obtaining an end material with good mechanical performance, resistant in oxidizing atmospheres and a controlled dimensional stability, characterized in that it is composed of a component with negative coefficient of thermal expansion and ceramic materials of an oxidic nature, with a porosity of less than 10 vol %, with a coefficient of thermal expansion adjusted according to the composition between −6×10⁻⁶ and +6×10⁻⁶ C⁻¹ in the temperature range between −150° C. and +750° C., a resistance to fracture above 80 MPa and an tensile modulus exceeding 50 GPa and a low density.

A third aspect of the present invention relates to the use of the material as a material in the manufacture of ceramic components with high dimensional stability. And preferably in the manufacture of the structure of mirrors in astronomical telescopes and X-ray telescopes in satellites, optical elements in comet probes, meteorological satellites and microlithography, mirrors and frames in ring laser gyroscopes, resonance laser distance indicators, measuring boards and standards in high precision measurement technologies.

Throughout the description and the claims the word “comprises” and its variants are not intended to exclude other technical characteristics, additives, components or steps. For persons skilled in the art, other objects, advantages and characteristics of the invention will be inferred in part from the description and in part from the practice of the invention. The following examples and figures are provided by way of illustration, and are not intended to limit the present invention.

### DESCRIPTION OF THE FIGURES

FIG. 1. Shows the phase diagram of the Li₂O—Al₂O₃—SiO₂ system, showing the composition used in the examples of the present invention.

FIG. 2. Shows the α curves corresponding to the LAS/Al₂O₃ materials obtained by sintering in air in a conventional oven and SPS.

### EXAMPLES

Below, the invention will be illustrated with assays performed by the inventors, which reveal the specificity and efficacy of the ceramic composite material with high dimensional stability and controlled CTE in the range (−150, +750)° C. as a particular embodiment of the process object of the invention.

### Example 1

Composite material LAS/Al₂O₃ with CTE lower than |0.7|×10⁻⁶° C.⁻¹ in the range −150° C. to 750° C.

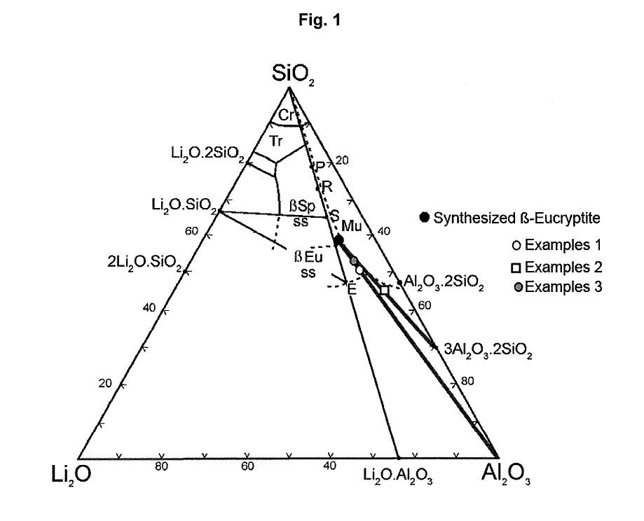

The starting materials are:
LAS powder with the composition LiAlSiO₄ (composition in FIG. 1) with average particle size of 1 μm and density 2.39 g/cm³.
Al₂O₃ powder with average particle size less than 160 nm and density 3.90 g/cm³.
Anhydrous ethanol (99.97% purity)

TABLE 1
Abbreviations used in FIG. 1.

| Abbreviation | Compound |
|---|---|
| Cr | Cristobalite |
| Tr | Tridymite |
| Mu | Mullite |
| B Sp ss | Spodumene solid solution |
| B Eu ss | Eucryptite solid solution |
| P | Petalite |
| R | Li orthoclase |
| S | Spodumene |
| E | Eucryptite |

872 g of LAS were used dispersed in 1400 g of ethanol. This was subsequently mixed with a suspension of 128 g of Al₂O₃ in 1000 g of ethanol. The whole mixture was homogenized using mechanical stirring for 60 minutes and then milled in an attrition mill operating at 300 rpm for 60 minutes. The suspension thus prepared was dried by atomization, yielding nanocomposite granules while at the same time ethanol is recovered from the process. The milling step made it possible to prepare a nanometre-sized homogeneous powder and improved densification of the end material.

The dry product was subjected to a forming process using cold isostatic pressing at 200 MPa. A formed material was obtained which was sintered in air in a conventional at 1350° C., with a stay of 240 minutes and heating ramp of 5° C./min. After this stay cooling was also controlled at 5° C./min to a temperature of 900 ° C. and from that temperature it was allowed to cool the oven without temperature control.

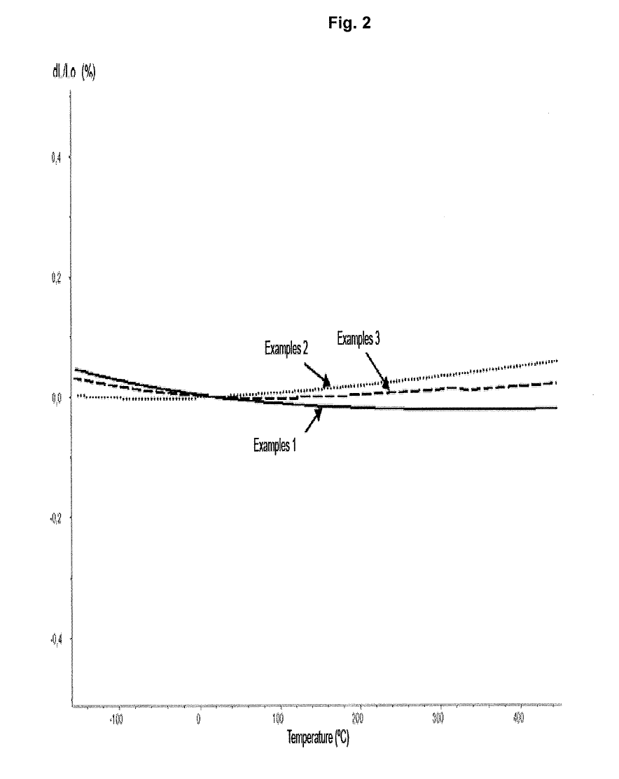

The resulting material was characterized by its real density (helium pycnometry), apparent density (Archimedes' method), Young's modulus (resonance frequency method in a Grindosonic unit), resistance to fracture (four point bending method in an INSTRON 8562 unit), and coefficient of thermal expansion (dilatometer, make: NETZCH, model: DIL402C). The corresponding values appear in Table 2. The variation of the coefficient of thermal expansion with the temperature is represented in FIG. 2.

TABLE 2
Results obtained from the characterization
of the materials LAS/Al₂O₃

| Property | Ex. 1 |
|---|---|
| % Theoretical density | 93.70 |
| 100 × (dₐₚₚₐᵣₑₙₜ/dᵣₑₐₗ) | |
| Young's modulus (GPa) | 110 |
| Resistance to fracture (Mpa) | 138 |
| CTE(×10⁻⁶ ° C.⁻¹) (−150, 450) ° C. | −1.08 |
| CTE(×10⁻⁶ ° C.⁻¹) (−150, 750) ° C. | −0.70 |

### Example 2

Composite Material LAS/3Al₂O₃.2SiO₂with CTE<|0.9|×10⁻⁶° C.⁻¹ in the range −150° C. to 450° C.

The starting materials are:
LAS powder with the composition LiAlSiO₄ (composition in FIG. 1) with average particle size of 1 μm and density 2.39 g/cm³.
Mullite powder (3Al₂O₃.2SiO₂), with average particle size of 700 nm and density 3.05 g/cm³.
Anhydrous ethanol (99,97% purity)

562 g of LAS were used which were dispersed in 1400 g of ethanol. It was then mixed with a suspension of 438 g of Al₂O₃ in 1000 g of ethanol. The combination was homogenized by mechanical stirring during 60 minutes and is then milled in an attrition mill loaded with 9 kg of grinding balls operating at 300 r.p.m. during a further 60 minutes.

The suspension was dried by atomization, obtaining nanocomposite granules whist recovering the ethanol from the process.

The dry product thus obtained was subjected to a forming and sintering process using Spark Plasma Sintering (SPS). For this, 50 grams of the material were introduced in a graphite mould with a diameter of 40 mm and it was uniaxially pressed at 5 MPa. Thereafter, the sintering was carried out by applying a maximum pressure of 16 MPa, with a heating ramp of 100° C./min up to 1250° C. and a 2-minute stay.

The resulting material was characterized by its real density (helium pycnometry), apparent density (Archimedes' method), Young's modulus (resonance frequency method in a Grindosonic unit), resistance to fracture (four point bending method in an INSTRON 8562 unit), and coefficient of thermal expansion (dilatometer, make; NETZCH, model; DIL402C). The corresponding values appear in Table 3. The variation of the coefficient of thermal expansion with the temperature is represented in FIG. 2.

TABLE 3
Results obtained from the characterization
of the LAS/Al₂O₃ materials.

| Property | Ex. 2 |
|---|---|
| % Theoretical density | 99.99 |
| 100 × (dₐₚₚₐᵣₑₙₜ/dᵣₑₐₗ) | |
| Young's module (GPa) | 128 |
| Resistance to fracture (MPa) | 166 |
| CTE(×10⁻⁶ ° C.⁻¹) (−150, 450) ° C. | 0.90 |
| CTE(×10⁻⁶ ° C.⁻¹) (−150, 750) ° C. | n.d |

### Example 3

Composite Material LAS/3Al₂O₃, 2SiO₂ with CTE<|0.6|×10⁻⁶° C.⁻¹ in the range −150° C. to 450° C.

The starting materials are:
LAS powder with the composition LiAlSiO₄ (composition in FIG. 1) with average particle size of 1 μm and density 2.39 g/cm³.
Al₂O₃, powder with average particle size less than 160 nm and density 3.90 g/cm³.
Anhydrous ethanol (99.97% purity)

843 g of LAS were used which were dispersed in 1400 g of ethanol. This was then mixed with a suspension of 157 g of n-SiC in 1000 g of ethanol. The combination was homogenized by mechanical stirring during 60 minutes and was then milled in an attrition mill loaded with 9 kg of grinding balls operating at 300 r.p.m. during a further 60 minutes.

The suspension was dried by atomization, obtaining nanocomposite granules whist recovering the ethanol from the process.

The dry product thus obtained was subjected to a forming and sintering process using Hot-Press. For this, 50 grams of the material were introduced in a graphite mould with a diameter of 50 mm and this was uniaxially pressed at 15 MPa. Next, the sintering was carried out by applying a maximum pressure of 50 MPa, with a heating ramp of 5° C./min to 1200° C. and a 60-minute stay.

The resulting material was characterized by its real density (helium pycnometry), apparent density (Archimedes' method), Young's modulus (resonance frequency method in a Grindosonic unit), resistance to fracture (four point bending method in an INSTRON 8562 unit), and coefficient of thermal expansion (dilatometer, make: NETZCH, model: DIL402C). The corresponding values appear in Table 4. The variation of the coefficient of thermal expansion with the temperature is represented in FIG. 2.

TABLE 4
Results obtained from the characterization
of the LAS/Al₂O₃ materials

| Property | Ex. 3 |
|---|---|
| % Theoretical density | 100.0 |
| 100 × (dₐₚₚₐᵣₑₙₜ/dᵣₑₐₗ) | |
| Young's module (GPa) | 135 |
| Resistance to fracture (MPa) | 164 |
| CTE(×10⁻⁶ ° C.⁻¹) (−150, 450) ° C. | −0.15 |
| CTE(×10⁻⁶ ° C.⁻¹) (−150, 750) ° C. | n.d |

1. A composite material comprising:
a. A ceramic component, and
b. Oxidic ceramic particles,
wherein said material has a controlled coefficient of thermal expansion between −6×10⁻⁶° C^{31 1} and 6.01×10⁻⁶° C⁻¹

2. The composite material according to claim 1, wherein the ceramic component is selected from between the Li₂O:Al₂O₃:SiO₂ or MgO:Al₂O₃:SiO₂ systems.

3. The composite material according to claim 2, wherein the ceramic component is β-eucryptite or cordierite.

4. The composite material according to claim 1, wherein the ceramic component has a percent with respect to the end material greater than 0.1% by volume.

5. The composite material according to claim 1, wherein the oxidic ceramic particles are an oxide of at least one element, wherein said element is selected from: Li, Mg, Ca, Y, Ti, Zr, Al, Si, Ge, In, Sn, Zn, Mo, W, Fe or any combination thereof.

6. The composite material according to claim 5, wherein the oxidic ceramic particles are selected from between alumina or mullite.

7. The composite material according to claim 5, wherein the oxidic ceramic particles have a spinel type crystal structure.

8. The composite material according to claim 7, wherein the oxidic ceramic particles are selected from between MgAl₂O₄, FeAl₂O₄ or any of the solid solutions between them.

9. The composite material according to claim 5, wherein the oxidic ceramic particles have a size of between 20 and 1000 nm.

10. A process to obtain the composite material according to claim 1 comprising the stages:
a. Mixing of the ceramic component with the oxidic ceramic particles in a solvent
b. drying of the mixture obtained in (a);
c. forming of the material obtained in (b);
d. sintering of the material obtained in (c).

11. The process according to claim 10, wherein the solvent is selected from water, anhydrous alcohol or any of their combinations.

12. The process according to claim 11, wherein the anhydrous alcohol, is anhydrous ethanol.

13. The process according to claim 10, wherein the mixing of stage (a) is performed in an attrition mill operating at 100 to 500 r.p.m.

14. The process according to claim 10, wherein the drying of stage (b) is performed by atomization.

15. Process The process according to claim 10, wherein the forming of stage (c) is performed by cold or hot pressing.

16. The process according to claim 15, wherein the cold pressing is isostatic and is performed at pressures between 100 and 400 MPa.

17. The process according to claim 10, wherein stage (d) of sintering is performed without the application of pressure or applying uniaxial pressure.

18. The process according to claim 17, wherein the sintering is performed at temperatures between 700 and 1600° C.

19. The process according to claim 17, wherein the sintering without applying pressure is performed at a temperature between 1100 and 1600° C., with a heating ramp between 0.5 and 50° C./min, remaining at this temperature for 0.5 and 10 hours.

20. The process according to claim 19, wherein additionally subsequent cooling is performed reaching 900° C. with a ramp between 2 and 10° C./min.

21. The process according to claim 10, wherein stages (c) and (d) are performed in a single stage.

22. The process according to claim 21, wherein the forming and sintering by Spark Plasma Sintering is performed by applying a uniaxial pressure of between 2 and 100 MPa, at a temperature between 700 and 1600° C., and a heating ramp between 2 and 300° C./min, remaining at this temperature for a period between 1 and 120 min.

23. The process according to claim 21, wherein the forming and sintering by Hot-Press sintering is performed by applying a uniaxial pressure between 5 and 150 MPa, at a temperature between 900 and 1600° C., with a heating ramp of between 0.5 to 100° C./min, remaining at this temperature for a period between 0.5 to 10 hours.

24. A material with high dimensional stability comprising the composite material according to claim 1.

25. (canceled)
